(19) United States
(12) Patent Application Publication
(10) Pub. No.: US 2008/0189019 A1
(43) Pub. Date: Aug. 7, 2008

(54) Method for Operating a Hydraulic Braking System for Motor Vehicles

(75) Inventors: Samir Attayebi, Frankfurt am Main (DE); Marcus Bletz, Wolfenhausen (DE); Oliver Huth, Kronberg (DE); Mohieddine Challouf, Nauheim (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG & CO. OHG

(21) Appl. No.: 11/793,632

(22) PCT Filed: Dec. 21, 2005
(86) PCT No.: PCT/EP2005/057058

§ 371 Date: Nov. 26, 2007

(30) Foreign Application Priority Data
Dec. 21, 2004 (DE) 10 2004 062 720.7
Dec. 13, 2005 (DE) 10 2005 059 937.0

(51) Int. Cl. G06F 19/00

(52) U.S. Cl. 701/70

(57) ABSTRACT

The invention relates to a method for operating a hydraulic braking system for motor vehicles, comprising a service brake system and a parking brake device, with the service :Drake system including a pedal-operable hydraulic pressure generator, to which two brake circuits with at least one externally controllable hydraulic pressure source are connected, and a hydraulically operable front-axle wheel brake provided with inlet and outlet valves and a hydraulically operable rear-axle wheel brake provided with inlet and outlet valves are associated with each one brake circuit, and with the parking brake device including means for arresting the brake pistons of the rear-axle wheel brakes, the brake pistons being acted upon by hydraulic pressure supplied by the pressure source for the purpose of activation or deactivation of the parking brake device.

In order to render the working time of the externally controllable hydraulic pressure source shorter during deactivation of the parking brake device, according to the invention, the hydraulic pressure is used at least partly to apply the front axle wheel brakes after deactivation of the parking brake device.

The present invention relates to a method for operating a hydraulic braking system for motor vehicles, comprising a service brake system and a parking brake device, with the service brake system including a pedal-operable hydraulic pressure generator, to which two brake circuits with at least one externally controllable hydraulic pressure source are connected, and a hydraulically operable front-axle wheel brake provided with inlet and outlet valves and a hydraulically operable rear-axle wheel brake provided with inlet and outlet valves are associated with each one brake circuit, and with the parking brace device including means for arresting the brake pistons of the rear-axle wheel brakes, the brake pistons being acted upon by hydraulic pressure supplied by the pressure source for the purpose of activation or deactivation of the parking brake device.

DE 102 13 346 A1 discloses a method wherein a service brake device brings about a continuous transition of the brake pressure or the brake application force of at least two vehicle axles onto a first axle on which a parking brake device acts as well. This method is employed in a transition from a service brake operation to a parking brake operation. In parking brake devices, which are acted upon by hydraulic pressure of a pressure source for the purpose of activation or deactivation, it is especially important that the pressure buildup is performed at low noise.

In view of the above, an object of the invention is to develop a method, which performs the transition from a parking brake operation to a service brake operation and from a service brake operation to a parking brake operation simply and at low noise to the best possible degree.

According to the invention, this object is achieved in that the hydraulic pressure, after deactivation of the packing brake device, is used at least partly for the operation of the front-axle wheel brakes. This measure allows safely folding the motor vehicle after the deactivation of the parking brake device and reducing the working time of the hydraulic pressure source.

In a particularly favorable improvement of the subject matter of the invention, the following process steps are performed:
closing the inlet valves associated with the front-axle wheel brakes;
buildup of hydraulic pressure by the hydraulic pressure source in the rear-axle wheel brakes;
deactivating the parking brake device and terminating the hydraulic pressure buildup;
opening the inlet valves associated with the front-axle wheel brakes.

In another particularly favorable improvement, it is provided that an additional pressure buildup is carried out by the hydraulic pressure source after the inlet valves associated with the front-axle wheel brakes have been opened.

The object of the invention is also achieved in that hydraulic pressure introduced into the front-axle wheel brakes is used at least partly for the activation of the parking brake device on the rear-axis wheel brakes. It is achieved by this measure that the pressure buildup required for the activation of the parking brake device is performed at low noise. In addition, the operator does not feel any pressure pulsations at the brake pedal, which are caused by the pressure source.

In a particularly favorable improvement of the subject matter of the invention, the following process steps are performed:
buildup of hydraulic pressure by the hydraulic pressure source or by the operator in the front-axle and rear-axle wheel brakes;
closing the inlet valves associated with the front-axle wheel brakes and opening the outlet valves associated with the front-axle wheel brakes ;
displacing the pressure fluid volume introduced into the front-axle wheel brakes into a low-pressure accumulator;
buildup of additional hydraulic pressure by the hydraulic pressure source in the rear-axle wheel brakes;
activating the parking brake device and terminating the hydraulic pressure buildup;
opening the outlet valves associated with the rear-axle wheel brakes.

The invention will be described in detail hereinbelow by way of an embodiment, making reference to the accompanying drawings. In the drawings:

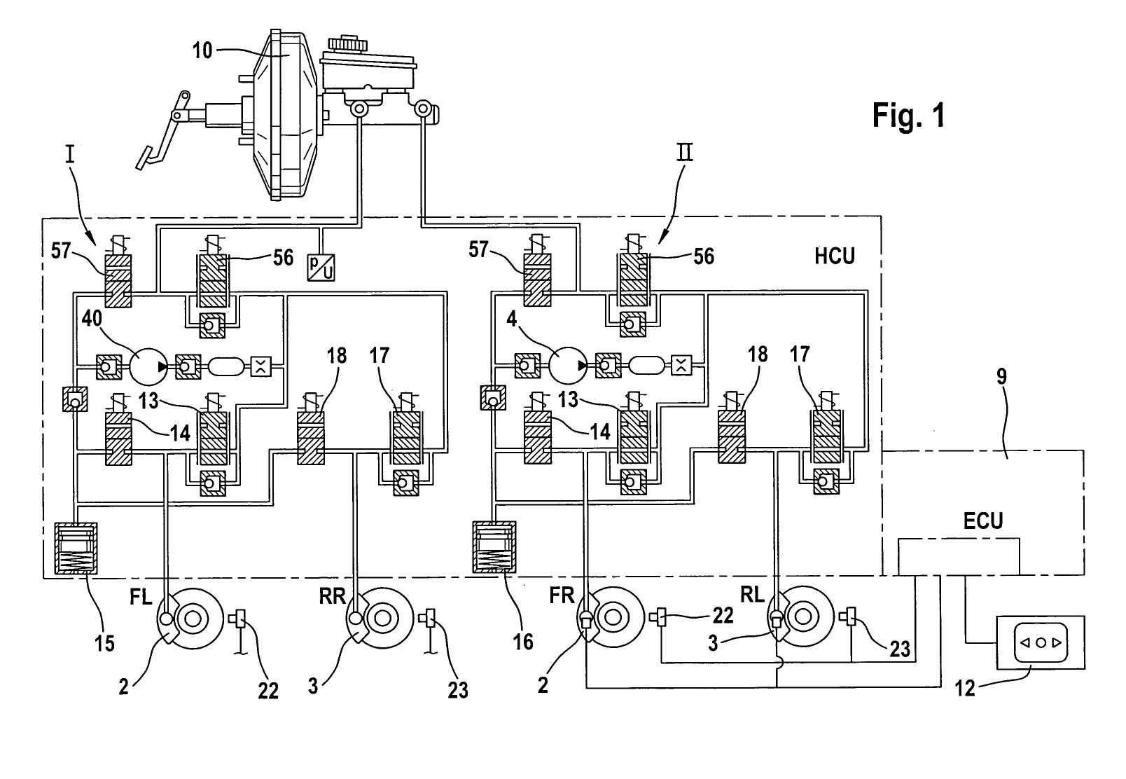

FIG. 1 is a schematic circuit diagram of a hydraulic brake system, in which the method of the invention can be implemented;

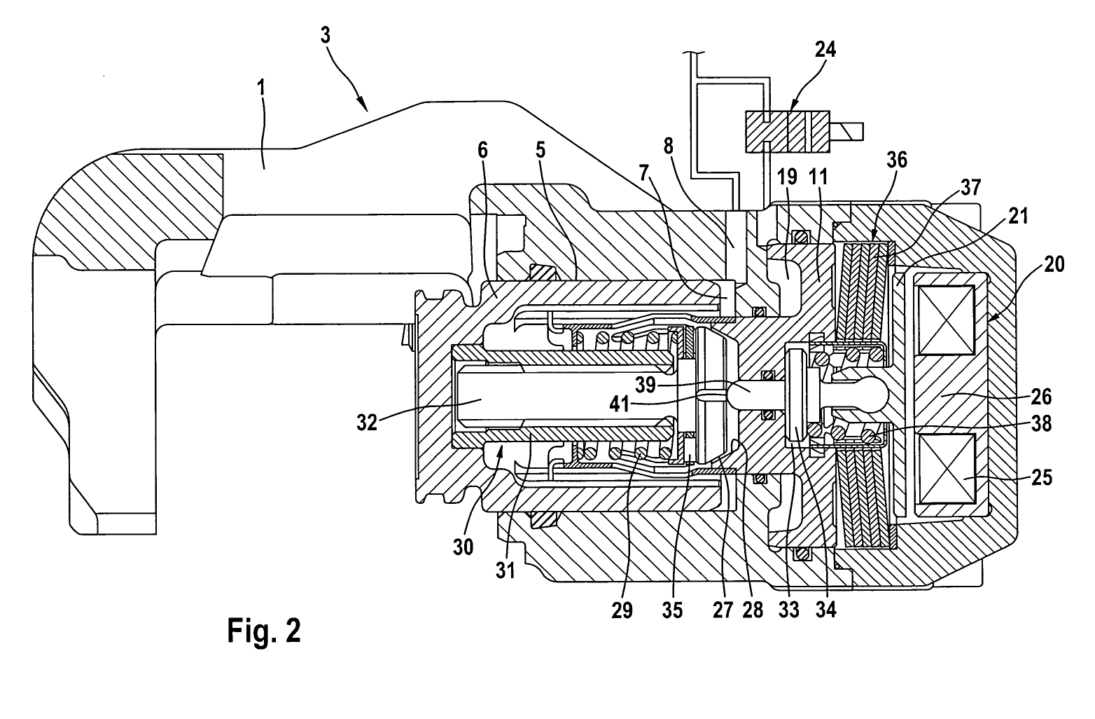

FIG. 2 is an axial cross-sectional view of a hydraulic wheel brake for motor vehicles, which is employed on a vehicle axle in the brake system illustrated in FIG. 1;

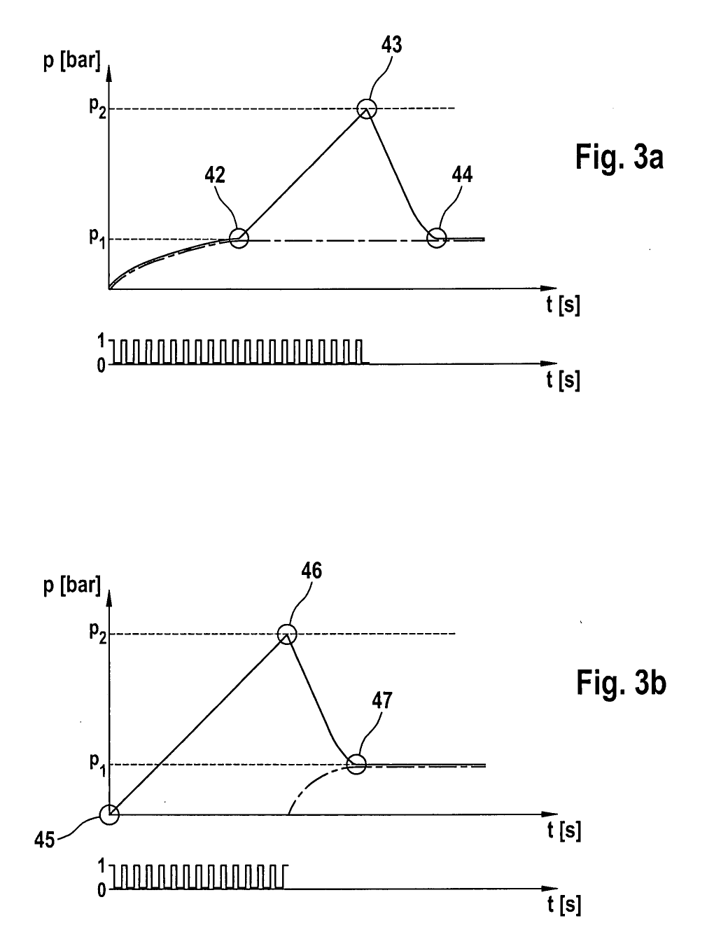

FIGS. 3a,b show time diagrams of the hydraulic pressure in front-axle and rear-axle wheel brakes in a transition from a parking brake operation to a service brake operation; and

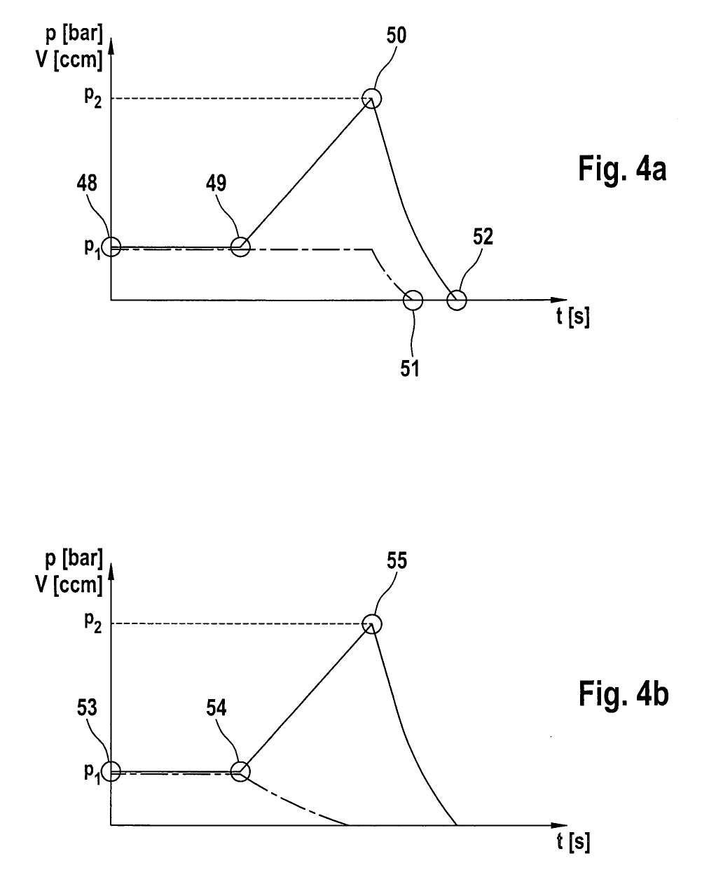

FIGS. 4a,b show time diagrams of the hydraulic pressure and the volume in front-axle and rear-axle wheel brakes in a transition from a service brake operation to a parking brake operation.

The circuit diagram of a brake system for motor vehicles illustrated in FIG. 1 includes two brake circuits I, II. A front-axle wheel brake 2 and a rear-axle wheel brake 2 is associated with each of the two brake circuits I, II. An arrangement of this type is also referred to as diagonal allotment. In contrast to the rear-axle wheel brakes 3, the front-axle wheel brakes 2 do not have any means for arresting the brake pistons. The rear-axle wheel brakes 3 with arresting means will be described in more detail by way of FIG. 2. Pressure is applied to the wheel brakes 2, 3 through inlet valves 13, 17 from a pedal-operated pressure generator 10, which is shown in FIG. 1 as a vacuum brake booster with a master brake cylinder connected downstream thereof. Pressure decrease in the wheel brakes 2, 3 takes place through outlet valves 14, 18, thereby brake fluid is supplied into low-pressure accumulators 15, 16. In addition, the brake system includes an electronic control unit 9 as well as two hydraulic pumps 4, 40 for the wheel brakes 2, 3 on both vehicle axles, the said pumps being jointly required to perform anti-lock control operations (ABS) and for control operations in the electronic stability program (ESP). Further, the hydraulic pumps 4, 40 generate hydraulic pressure necessary for the activation and deactivation of the parking brake device, as will be explained more closely by way of FIG. 2. There is also provision of separating valves 56, 57.

The hydraulic rear-axle wheel brake 3 with integrated parking brake function as illustrated in FIG. 2 includes a brake housing 1 straddling the outside edge of a brake disc (not shown) and two brake pads (likewise not shown). The Drake housing 1 forms on its inside surface a brake cylinder 5 receiving a brake piston 6 in an axially displaceable manner. By way of a hydraulic port 8, brake fluid can be fed into the working pressure chamber 7 that is formed between brake cylinder 5 and brake piston 6, so that brake pressure develops which displaces the brake piston 6 axially towards the brake disc. This will urge the brake pad facing the brake piston 6 against the brake disc, whereupon the brake housing 1, as a reaction, displaces in the opposite direction and thereby urges likewise the other brake pad against the brake disc.

As can be taken from FIG. 2 in addition, an energy accumulator 36 is arranged at the side of the brake housing 1 remote from the brake piston 6. Energy accumulator 36 is mainly comprised of a hydraulic accumulator pressure chamber 19, an accumulator piston 11 delimiting the accumulator pressure chamber 19, as well as a spring element 37 being designed as an assembly of cup springs and supported at the accumulator piston 11 in the example shown. The energy stored in the energy accumulator 36 acts on the brake piston 6 during a parking brake operation, as will be explained in more detail in the following.

A spindle drive or a threaded-nut/spindle assembly 30, respectively, forms the means for arresting the brake piston 6, which is necessary for realizing a parking brake function in the design illustrated in FIG. 2. The mentioned threaded-nut/spindle assembly 30 comprises a threaded nut 31 and a spindle 32 being in connection with each other by means of a non-self-locking thread. In this arrangement, the threaded nut 31 is rigidly connected to the brake piston 6, while the spindle 32 at its end remote from the brake piston 6 includes a preferably conical first friction surface 27, which can be moved into and out of engagement with a second friction surface 28 that is arranged in the accumulator piston 11 in a non-rotatable fashion. For this purpose, a force-transmitting element 39 is provided, which is received in a cylindrical stepped bore 33 in the accumulator piston 11, projects through the latter and forms a central bearing 41 for the spindle 32. After a relative movement of the force-transmitting element 39 in relation to the accumulator piston 11, the function of the central bearing 41 is omitted, and the two friction surfaces 27, 28 are in engagement with each other, as will be explained in more detail hereinbelow. Further, a spring 29 supported on the brake housing 1 biases the spindle 32 in the direction of the second friction surface 28 by the intermediary of an axial bearing 35.

The hydraulic rear-axle wheel brake is illustrated in FIG. 2 in the released condition of the parking brake device. To lock the parking brake device, the hydraulic pumps 4, 40 mentioned with respect to FIG. 1 are used to build up hydraulic pressure initially both in the working pressure chamber 7 and in the accumulator pressure chamber 19. To this end, an electrically operable valve, which is preferably configured as a normally closed (NC) valve 24, must adopt its open operating position. The brake piston 6 displaces to the left in the drawing as a reaction to the pressure buildup in the working pressure chamber 7, while the accumulator piston 11 is displaced to the right in the drawing in opposition to the action of force of the preloaded spring element 37. The spring element 37 compresses in this action. As this occurs, the accumulator piston 11 entrains the force-transmitting element 39 because a collar 54 designed at the force-transmitting element 39 is supported at the transition between small and large diameter of the stepped bore 33. The accumulator piston 11 and, hence, the force-transmitting element 39 are displaced to the right due to the above-mentioned pressure buildup in the accumulator pressure chamber 19 in FIG. 2 until an armature plate 21, which is in a force-transmitting connection with the force-transmitting element 39, moves into abutment with an electromagnetic actuator 20. In this action, the spindle 32 continues to bear against the central bearing 41 due to the action of force of the spring 29, with the result that the two friction surfaces 27, 28 cannot become engaged.

Subsequently, the electromagnetic actuator 20 is energized, with the result that the electromagnetic actuator 20 arrests the armature plate 21 in its stop position described above. In a following pressure reduction in the working pressure chamber 7 and in the accumulator pressure chamber 19, the brake piston 6 moves to the right in the drawing, while the accumulator piston 11 moves to the left. Arresting of the force-transmitting element 39 enables a relative movement between the force-transmitting element 39 and the accumulator piston 11, whereby the function of the central bearing 41 for the spindle 32 is cancelled and the two friction surfaces 27, 28 are moved into engagement with each other. The biased spring element 37 mentioned hereinabove presses the accumulator piston 11, the spindle 32 blocked due to the friction surfaces 27, 28 being in engagement, the threaded nut 31, and thus the brake piston 6 to the left in the drawing and against the brake disc (not shown), respectively. Thereby, the vehicle brake is locked in its applied condition. Thereafter the electromagnetic actuator 20 is no more energized, and the armature plate 21 and the force-transmitting element 39, respectively, are no more arrested. The valve 24 adopts its de-energized state, and it is hence closed. Thus, the hydraulic vehicle brake does not require energy and hydraulic pressure in order to maintain the locking engagement in the applied condition, which is considered advantageous.

To release the locking engagement, in turn, hydraulic pressure is built up in the working pressure chamber 7 and, after a corresponding actuation of the NC valve 24, likewise in the accumulator pressure chamber 19. The hydraulic pressure, in turn, would displace the brake piston 6 in FIG. 2 to the left and the accumulator piston 11 to the right. However, it is sufficient for unlocking the parking brake when the accumulator piston 11 is relieved from load. Another spring element 38, which moves the force-transmitting element 39 into abutment at the transition between small and large diameter of the stepped bore 33, urges the force-transmitting element 39 in the direction of the spindle 32 and pushes the engaged friction surfaces 27, 28 open, when the accumulator piston 11 is relieved from load in a corresponding manner. Thereafter, the force-transmitting element 39 forms a central bearing 41 for the spindle 32 again.

The method of the invention is now described by way of FIGS. 3b and 4b in connection with FIG. 1. In FIGS. 3a and 4a, a method known in the art is used to illustrate the method of the invention, FIGS. 3a, b and 4a, b exhibit the hydraulic pressure in the front-axle wheel brakes 2 in a dot-dash line, while the hydraulic pressure in the rear-axle wheel brakes 3 is drawn in a solid line. FIGS. 3a and 3b show in each case a time flow chart of a transition from a parking brace operation to a service brake operation. In addition, the working time of the hydraulic pumps 4, 40 is illustrated below the time axis, then the illustration adopts the value the hydraulic pumps 4, 40 are switched on, while the hydraulic pumps 4, 40 are switched off at the value ‘zero’.

In order to deactivate the parking brake device, it is necessary, as is described by way of FIG. 2, to build up hydraulic deactivation pressure p₂ in the working pressure chamber 7 and in the accumulator pressure chamber 19 of the rear-axle wheel brakes 3 by means of the hydraulic pumps 4, 40. To prevent the motor vehicle from starting to move after deactivation of the parking brake device, it is suitable to introduce hydraulic pressure p₁ into the front-axle and rear-axle wheel brakes 2, 3. This hydraulic pressure p₁ depends on the inclination of the motor vehicle and can be determined by means of an inclination sensor. Therefore, in the prior-art method illustrated in FIG. 3a, the above-mentioned inclination-responsive hydraulic pressure p₁ is initially introduced into the front-axle and rear-axle wheel brakes 2, 3, as is illustrated in position 42. The hydraulic pumps 4, 40 are in operation during this action. Subsequently, the hydraulic pressure is further increased only in the rear-axle wheel brakes 3, until the deactivation pressure p₂ of the parking brake device is reached. The hydraulic pumps 4, 40 are in operation until this time, which is designated by position 43. Thereafter, the hydraulic pressure in the rear-axle wheel brakes 3 is reduced again to the inclination-responsive hydraulic pressure p₁ (position 44).

It is less favorable in the prior art method as described by way of FIG. 3a that operation of the hydraulic pumps 4, 40 is relatively long.

Therefore, the method of the invention provides that the hydraulic pressure is employed at least partly for the operation of the front-axle wheel brakes 2 after the deactivation of the parking brake device in order to reduce, the working time of the pump this way. As is illustrated in FIG. 3b in position 45, hydraulic pressure is initially built up only ii the rear-axle wheel brakes 3. This means, the inlet valves 13 of the front-axle wheel brakes 2 mentioned by way of FIG. 1 are closed, and the hydraulic pumps 1, 40 build up hydraulic pressure in the rear-axle wheel brakes 3. As this occurs, the inlet valves 17 associated with the rear-axle wheel brakes 3 are opened and the outlet valves 18 are closed. The pressure buildup in the rear-axle wheel brakes 3 is continued until the above-mentioned deactivation pressure p₂ is reached, as position 46 shows. After the deactivation pressure p₂ is reached, the hydraulic pumps 4, 40 are disabled and the inlet valves 13 associated with the front-axle wheel brakes 2 are opened. This reduces the hydraulic pressure in the rear-axle wheel brakes 3, while the hydraulic pressure rises in the front-axle wheel brakes 2. Position 47 in FIG. 3b illustrates this relationship. The pressure that develops in front-axle and rear-axle wheel brakes 2, 3 roughly corresponds to the inclination-responsive hydraulic pressure p₁. If the deactivation pressure p₂ in the rear-axle wheel brakes 3 is insufficient to adjust the inclination-responsive hydraulic pressure p₁ in the wheel brakes 2, 3 on both axles, additional pressure buildup is initiated by the hydraulic pumps 4, 40 after the above-mentioned opening of the inlet valves 13 of the front-axle wheel brakes, until the inclination-responsive hydraulic pressure p₁ is prevailing in the wheel brakes 2, 3.

Thus, the idea of the method of the invention involves that when the parking brake is deactivated, the hydraulic pressure is initially generated only at the rear axle until the deactivation of the parking brake. When the deactivation is completed, the brake pressure is distributed from the rear axle to all wheel brakes so that the vehicle can continue to be maintained in position hydraulically. A major advantage can be seen in that the pump working time becomes shorter and, thus, the level of noise caused by the hydraulic pumps 4, 40 is reduced.

FIGS. 4a and 4b show in each case a time flow chart of a transition from a service brake operation to a parking brake operation. The hydraulic pressure p and the volume V of hydraulic pressure fluid in the front-axle and rear-axle wheel brakes 2, 3 are plotted on the ordinate. It is illustrated in position 48 in the prior art method shown in FIG. 4a that hydraulic pressure p₁ was introduced into the front-axle and rear-axle wheel brakes 2, 3. This hydraulic pressure p₁ can be introduced into the front-axle and rear-axle wheel brakes 2, 3 either by the hydraulic pumps 4, 40 within the limits of a comfort function or by the operator himself, e.g. by operation of the pedal-operable pressure generator 10. When transition from this service brake operation to a parking brake operation is desired, the hydraulic pressure in the rear-axle wheel brakes 3 is increased at time 49. As was explained by way of FIG. 2, an activation pressure p₂ is required to activate the parking brake device. Therefore, hydraulic pressure is built up in the rear-axle wheel brakes 3 by the pumps 4, 40 until this pressure value is reached, as is illustrated in position 50. After activation of the parking brake device, the hydraulic pressure in the front-axle and rear-axle wheel brakes 2, 3 is reduced again until the wheel brakes 1, 3 are unpressurized ii position 51 or 52, respectively.

It is arranged according to the invention that in the transition from a service brake operation to a parking brake operation, the hydraulic pressure introduced into the front-axle wheel brakes 2 is used at least partly for the activation of the parking Drake device on the rear-axle wheel brakes 3. The method is described in the following by way of FIG. 4b: Following a pressure p₁ introduced by the pumps 4, 40 or the operator into the front-axle and rear-axle wheel brakes 2, 3, the inlet valves 13 associated with the front-axle wheel brakes 2 are closed and the outlet valves 14 are opened. This causes displacement of the pressure fluid volume of the front-axle wheel brakes 2 into the low-pressure accumulators 15, 16. Simultaneously, the hydraulic pressure is increased in the rear-axle wheel brakes 3, as position 54 shows. As this occurs, the hydraulic pumps 4, 40 aspirate the pressure fluid volume that has been discharged from the front-axle wheel brakes 2 into the low-pressure accumulators 15, 16. Pressure buildup in the rear-axle wheel brakes 3 is continued until the activation pressure p₂ is reached (position 55) and the parking brake device 16 activated. Subsequently, the outlet valves 18 associated with the rear-axle wheel brakes open, and the hydraulic pressure in the rear-axle wheel brakes 3 decreases.

Consequently, the idea of the method of the invention implies that the hydraulic pressure or the hydraulic pressure fluid volume of the front-axle wheel brakes 2 out of a service brake operation is used to build up the activation pressure that is necessary to perform a parking brake operation. One major advantage lies in the reduction of the level of noise caused by the hydraulic pumps 4, 40. Besides, the separating valves 56, 57 mentioned with regard to FIG. 1 are closed during pressure buildup in the method of the invention so that the operator cannot feel pressure pulsations at the brake pedal, which are produced by the pumps 4, 40. In addition, it is achieved by closing the separating valves 56, 57 that the operator does not build up hydraulic pressure in opposition to the direction of effect of the hydraulic pumps 4, 40.

### LIST OF REFERENCE NUMERALS

1 brake housing

2 front-axle wheel brakes

3 rear-axle wheel brakes

4 hydraulic pump

5 brake cylinder

6 brake piston

7 working pressure chamber

8 hydraulic connection

9 control unit

10 pedal-operable pressure generator

11 accumulator piston

12 operating element

13 inlet valves front axle

14 outlet valves front axle

15 low-pressure accumulator

16 low-pressure accumulator

17 inlet valves rear axle

18 outlet valves rear axle

19 accumulator pressure chamber

20 electromagnetic actuator

21 armature plate

22 wheel steed sensors front axle

23 wheel speed sensors rear axle

24 hydraulic NC valve

25 coil

26 yoke

27 friction surface

28 friction surface

29 spring

30 threaded-nut/spindle assembly

31 threaded nut

32 spindle

33 stepped bore

34 collar

35 axial bearing

36 energy accumulator

37 spring element

38 spring element

39 force-transmitting element

40 hydraulic pump

41 central bearing

56 separating valves

57 Separating valves

1. Method for operating a hydraulic braking system for motor vehicles, comprising a service brake system and a parking brake device, with the service brake system including a pedal-operable hydraulic pressure generator (10), to which two brake circuits (I, II) with at least one externally controllable hydraulic pressure source (4, 40) are connected, and a hydraulically operable front-axle wheel brake (2) provided with inlet and outlet valves (13, 14) and a hydraulically operable rear-axle wheel brake (3) provided with inlet and outlet valves (17, 18) are associated with each one brake circuit (I, II), and with the parking brake device including means for arresting the brake pistons of the rear-axle wheel brakes (3), the brake pistons being acted upon by hydraulic pressure supplied by the pressure source (4, 40) for the purpose of activation or deactivation of the parking brake device, characterized in that the hydraulic pressure, after deactivation of the parking brace device, is used at least partly for the operation of the front-axle wheel brakes (2).

2. Method as claimed in claim 1, characterized in that the following process steps are performed:
closing the inlet valves (13) associated with the front-axle wheel brakes (2);
buildup of hydraulic pressure by the hydraulic pressure source (4, 40) in the rear-axle wheel brakes (3);
deactivating the parking brake device and terminating the hydraulic pressure buildup;
opening the inlet valves (13) associated with the front-axle wheel brakes (2).

3. Method as claimed in claim 2, characterized in that additional pressure buildup is carried out by the hydraulic pressure source (4, 40) after the inlet valves (13) associated with the front-axle wheel brakes (2) have been opened.

4. Method as claimed in any one of the preceding claims, characterized in that hydraulic pressure introduced into the front-axle wheel brakes (2) is used at least partly for the activation of the parking Drake device on the rear-axle wheel brakes (3).

5. Method as claimed in claim 4, characterized in that the following process steps are performed:
buildup of hydraulic pressure by the hydraulic pressure source (4, 40) or by the operator in the front-axle and rear-axle wheel brakes (2, 3);
closing the inlet valves (13) associated with the front-axle wheel brakes (29) and opening the outlet valves (14) associated with the front-axle wheel brakes (2);
displacing the pressure fluid volume introduced into the front-axle wheel brakes (2) into a low-pressure accumulator (15, 16);
buildup of additional hydraulic pressure by the hydraulic pressure source (4, 40) in the rear-axle wheel brakes (3);
activating the parking brake device and terminating the hydraulic pressure buildup;
opening the outlet valves (18) associated with the rear-axle wheel brakes (2).
